(19) United States
(12) Patent Application Publication
(10) Pub. No.: US 2004/0096723 A1
(43) Pub. Date: May 20, 2004

(54) Fuel cell gasket

(75) Inventors: Mark Kevitt Debe, Stillwater, MN (US); Andrew James Steinbach, Minneapolis, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/294,098

(22) Filed: Nov. 14, 2002

(51) Int. Cl. H01M 8/02

(52) U.S. Cl. 429/35; 429/30

(57) ABSTRACT

A gasketed fuel cell membrane electrode assembly is provided comprising a fuel cell membrane electrode assembly and a gasket, where the gasket comprises a closed-cell foam rubber, typically a silicone foam rubber. The membrane electrode assembly (MEA) typically comprises a peripheral sealing zone, in which the MEA consists essentially of its central ion conducting membrane layer or catalyst coated membrane layer and a closed-cell foam rubber gasket optionally attached with an adhesive. Typically the gasketed fuel cell membrane electrode assembly according to the present invention comprises no hard stop layer.

This invention was made with Government support under Cooperative Agreement DE-FC02-99EE50582 awarded by DOE. The Government has certain rights in this invention.

### FIELD OF THE INVENTION

This invention relates to a gasketed fuel cell membrane electrode assembly comprising a closed-cell foam rubber gasket and, typically, no hard stop layer.

### BACKGROUND OF THE INVENTION

U.S. Ser. No. 2001/0,019,790 and U.S. Ser. No. 2001/0,019,791 disclose a fuel cell comprising a multi-lobe gasket which may be molded to a polymer electrolyte membrane. The gasket is preferably silicone rubber or fluorosilicone.

U.S. Pat. No. 6,337,120 discloses a gasket made of liquid rubber formed into a groove of a sheet material by injection molding.

U.S. Pat. No. 6,261,711 discloses a seal for a fuel cell which includes a gasket disposed within a groove in a fuel cell flow plate and an opposing compressible member. Both may be made of polymers, such as EPDM or silicone polymers.

U.S. Pat. No. 6,159,628 discloses a fuel cell including porous substrates impregnated at their periphery with a thermoplastic material.

U.S. Pat. No. 6,080,503 discloses a fuel cell wherein a MEA is adhesively bound to one or more separator plates.

U.S. Pat. No. 6,057,054 discloses, in some embodiments, an MEA having co-extensive polymer electrolyte membrane and porous electrode layers having a seal material such as silicone impregnated into the porous electrode layers. The reference discloses, in other embodiments, an MEA having a seal material impregnated into the porous electrode layers thereof, where the seal extends beyond the MEA.

U.S. Pat. No. 5,928,807 discloses a polymer electrolyte fuel cell including an elastic, plastically deformable and electrically conductive graphite seal.

U.S. Pat. No. 5,464,700 discloses a gasketing system for a fuel cell membrane electrode assembly (MEA) intended to minimize the amount of polymer electrolyte membrane material in the fuel cell by employing a gasketing material instead of polymer electrolyte membrane material at the periphery. The gasketing material is preferably a nonhydrophilic thermoplastic elastomer.

U.S. Pat. No. 5,264,299 discloses a porous support body for use in an MEA having a peripheral portion filled with elastomeric material, preferably a silicon rubber.

U.S. Pat. No. 4,721,555 discloses a solid seal means to be interposed between electrode frame members of an electrolysis cell. The reference describes electrolysis cells with an internal separator, such as chlor-alkali cells depicted in FIGS. 17 and 18, and electrolysis cells without an internal separator, such as a chlorate cells.

### SUMMARY OF THE INVENTION

Briefly, the present invention provides a gasketed fuel cell membrane electrode assembly comprising a fuel cell membrane electrode assembly and a gasket comprising a closed-cell foam rubber, such as a silicone foam rubber, and, typically, no hard stop layer.

In another aspect, the present invention provides a gasketed fuel cell membrane electrode assembly comprising a peripheral sealing zone in which said gasketed fuel cell membrane electrode assembly consists essentially of a ion conducting membrane or catalyst coated membrane, a closed-cell foam rubber gasket such as a silicone foam rubber gasket, optionally an adhesive, and, typically, no hard stop layer.

What has not been described in the art, and is provided by the present invention, is a gasketed fuel cell membrane electrode assembly comprising a closed-cell foam rubber gasket, and, in particular, one comprising no hard stop layer.

In this application:

“gasketed fuel cell membrane electrode assembly” means a fuel cell membrane electrode assembly with one or more gaskets associated therewith, regardless of whether the gaskets are bound to the membrane electrode assembly or merely held in place by mechanical forces;

“foam rubber” means a solid foam of a resilient elastic polymer, typically a natural rubber, a synthetic rubber, a polyurethane, a fluorosilicone rubber or most typically a silicone rubber; and

“hard stop” or “hard stop layer” means a layer in an membrane electrode assembly (MEA) which halts compression of the MEA at a fixed thickness or strain, other than: an ion conducting membrane layer, a catalyst layer, a gas diffusion layer, a seal or gasket layer or an adhesive layer.

It is an advantage of the present invention to provide a gasketed fuel cell membrane electrode assembly that seals over a wide range of compression conditions.

### DETAILED DESCRIPTION OF PREFERRED EMBODIMENTS

The present invention provides a gasketed fuel cell membrane electrode assembly comprising a fuel cell membrane electrode assembly and a gasket, where the gasket comprises a closed-cell foam rubber, typically a silicone foam rubber. The membrane electrode assembly (MEA) typically comprises a peripheral sealing zone, in which the MEA consists essentially of its central ion conducting membrane layer or catalyst coated membrane layer and a closed-cell foam rubber gasket optionally attached with an adhesive. Typically the gasketed fuel cell membrane electrode assembly according to the present invention comprises no hard stop layer.

A membrane electrode assembly (MEA) is the central element of proton exchange membrane fuel cells such as hydrogen fuel cells. Fuel cells are electrochemical cells which produce usable electricity by the catalyzed combination of a fuel such as hydrogen and an oxidant such as oxygen. Typical MEA's comprise an ion conducting membrane (ICM) (also known as a proton exchange membrane (PEM)), which functions as a solid electrolyte. One face of the ICM is in contact with an anode electrode layer and the opposite face is in contact with a cathode electrode layer. Each electrode layer includes electrochemical catalysts, typically including platinum metal. Gas diffusion layers (GDL's) facilitate gas transport to and from the anode and cathode electrode materials and conduct electrical current. In a typical PEM fuel cell, protons are formed at the anode via hydrogen oxidation and transported to the cathode to react with oxygen, allowing electrical current to flow in an external circuit connecting the electrodes. The GDL may also be called a fluid transport layer (FTL) or a diffuser/current collector (DCC). The anode and cathode electrode layers may be applied to the ICM or to the GDL during manufacture, so long as they are disposed between ICM and GDL in the completed MEA. In the practice of the present invention, any suitable MEA's may be used.

Any suitable ICM may be used in the practice of the present invention. The ICM typically has a thickness of less than 50 μm, more typically less than 40 μm, more typically less than 30 μm, and most typically about 25 μm. The ICM is typically comprised of a polymer electrolyte that is an acid-functional fluoropolymer, such as Nafion® (DuPont Chemicals, Wilmington Del.) and Flemion™ (Asahi Glass Co. Ltd., Tokyo, Japan). The polymer electrolytes useful in the present invention are typically preferably copolymers of tetrafluoroethylene and one or more fluorinated, acid-functional comonomers. Typically the polymer electrolyte bears sulfonate functional groups. Most typically the polymer electrolyte is Nafion®. The polymer electrolyte typically has an acid equivalent weight of 1200 or less, more typically 1100 or less, more typically 1050 or less, and most typically about 1000.

Any suitable GDL may be used in the practice of the present invention. Typically the GDL is comprised of sheet material comprising carbon fibers. Typically the GDL is a carbon fiber construction selected from woven and non-woven carbon fiber constructions. Carbon fiber constructions which may be useful in the practice of the present invention may include: Toray™ Carbon Paper, SpectraCarb™ Carbon Paper, AFN™ non-woven carbon cloth, Zoltek™ Carbon Cloth, and the like. The GDL may be coated or impregnated with various materials, including carbon particle coatings, hydrophilizing treatments, and hydrophobizing treatments such as coating with polytetrafluoroethylene (PTFE).

Any suitable catalyst may be used in the practice of the present invention. Typically, carbon-supported catalyst particles are used. Typical carbon-supported catalyst particles are 50-90% carbon and 10-50% catalyst metal by weight, the catalyst metal typically comprising Pt for the cathode and Pt and Ru in a weight ratio of 2:1 for the anode. Typically, the catalyst is applied to the ICM or to the GDL in the form of a catalyst ink. The catalyst ink typically comprises polymer electrolyte material, which may or may not be the same polymer electrolyte material which comprises the ICM. The polymer electrolyte is typically an acid-functional fluoropolymer, such as Nafion® (DuPont Chemicals, Wilmington Del.) and Flemion™ (Asahi Glass Co. Ltd., Tokyo, Japan). The polymer electrolytes useful, in inks for use in the present invention are typically preferably copolymers of tetrafluoroethylene and one or more fluorinated, acid-functional comonomers. Typically the polymer electrolyte bears sulfonate functional groups. Most typically the polymer electrolyte is Nafion®. The polymer electrolyte typically has an equivalent weight of 1200 or less, more typically 1100 or less, more typically 1050 or less, and most typically about 1000. The catalyst ink typically comprises a dispersion of catalyst particles in a dispersion of the polymer electrolyte. The ink typically contains 5-30% solids (i.e. polymer and catalyst) and more typically 10-20% solids. The electrolyte dispersion is typically an aqueous dispersion, which may additionally contain alcohols and polyalcohols such a glycerin and ethylene glycol. The water, alcohol, and polyalcohol content may be adjusted to alter Theological properties of the ink. The ink typically contains 0-50% alcohol and 0-20% polyalcohol. In addition, the ink may contain 0-2% of a suitable dispersant. The ink is typically made by stirring with heat followed by dilution to a coatable consistency.

The catalyst may be applied to the ICM or the GDL by any suitable method, including both hand and machine methods, including hand brushing, notch bar coating, fluid bearing die coating, wire-wound rod coating, fluid bearing coating, slot-fed knife coating, three-roll coating, or decal transfer. Coating may be achieved in one application or in multiple applications. Where the catalyst electrode material is coated directly on the ICM, the resulting three-layer construction is a catalyst-coated membrane (CCM). The term 5-layer MEA specifically describes a CCM with GDL's attached. The catalyst electrode layers may be applied to the ICM or to the GDL during manufacture, so long as they are disposed between ICM and GDL in the completed MEA so that the resulting 5-layer MEA comprises, in order: GDL, catalyst, ICM, catalyst, GDL. The GDL may be joined to the rest of the MEA by any suitable method, including lamination under heat and/or pressure.

Alternately, a CCM may be made using a nanostructured catalyst, as disclosed in U.S. Pat. No. 5,338,430 (nanostructured electrodes embedded in solid polymer electrolyte) or U.S. Pat. No. 5,879,828 (MEA's having electrode layers comprising nanostructured elements).

Typically the catalyst is confined to an inner active area of the MEA. However, where a nanostructured catalyst is used the catalyst typically extends to the edge of the ICM. Typically the GDL is confined to an inner area of the MEA. Thus, the MEA may comprise a peripheral sealing zone where gasket or seal material may be applied to the ICM or CCM. The gasket or seal may be bound to the MEA by a suitable adhesive or held in place by mechanical forces only. Where a hard stop layer is incorporated into the MEA, it typically underlies the gasket or seal. The hard stop layer may be bound to the MEA and/or gasket by a suitable adhesive or held in place by mechanical forces only. The periphery of the MEA may also include holes that pass through the MEA, which may also pass through any gasket and/or any hard stop layer. These holes may serve as manifolds for reactant or product fluids or for cooling fluids, in which case the gasket serves not only to seal the outer edge of the active area of the MEA but also to preserve the integrity of the manifold and to separate it from the active area. Such holes may also serve for mechanical purposes, e.g. attachment or registration, or for other purposes.

The gasket according to the present invention is made of a closed-cell foam rubber. The closed-cell foam rubber may be made of any suitable resilient elastic polymer, including natural rubber, synthetic rubber, polyurethane, fluorosilicone rubber or, most typically, silicone rubber. One suitable closed-cell silicone foam rubber is product HT800 manufactured by Rogers Corporation, High Performance Foams Division, Bisco Materials Unit, 2300 East Devon Avenue, Elk Grove Village, Ill. 60007-6120 and available from Stockwell Rubber Company, Inc., 4749 Talbot St., Philadelphia, Pa. 19136, having a nominal thickness of 1/32″ (0.79 mm) and the following specifications:

Compression Force Deflection: 8 psi (55 MPa) at 25% deflection

Compression Set at 70° C.: <1%

Compression Set at 100° C.: <5%

Density: 20 lb/ft³ (0.32 kg/liter)

Tensile Strength: 45 psi (310 MPa)

Elongation: 80%

Volume Resistivity: 10¹⁴ ohm-cm

The gasket material typically requires a compression force at 25% strain (deflection) of less than 180 MPa, more typically less than 120 MPa, and most typically less than 60 MPa. The gasket material typically exhibits a compression set at 70° C. of less than 5%, more preferably less than 3%, and most preferably less than 1%. The gasket material is typically not electrically conductive.

The gasket may have any suitable uncompressed thickness, such that it will seal in use. Typically, the uncompressed thickness of the gasket is between 50% and 300% of the uncompressed thickness of the GDL, more typically between 80% and 200% of the thickness of the GDL, and most typically between 100% and 150% of the thickness of the GDL.

The MEA's according to the present invention may be used in a fuel cell stack such as is described in co-pending patent application Ser. No. __/___,___, filed on even date herewith and incorporated herein by reference.

This invention is useful in the design and manufacture of fuel cell MEA's, stacks and systems.

Various modifications and alterations of this invention will become apparent to those skilled in the art without departing from the scope and principles of this invention, and it should be understood that this invention is not to be unduly limited to the illustrative embodiments set forth hereinabove. All publications and patents are herein incorporated by reference to the same extent as if each individual publication or patent was specifically and individually indicated to be incorporated by reference.

We claim:

1. A gasketed fuel cell membrane electrode assembly comprising a fuel cell membrane electrode assembly and a gasket comprising a closed-cell foam rubber.

2. The gasketed fuel cell membrane electrode assembly according to claim 1 wherein said closed-cell foam rubber comprises silicone.

3. The gasketed fuel cell membrane electrode assembly according to claim 1 wherein said closed-cell foam rubber consists essentially of silicone.

4. The gasketed fuel cell membrane electrode assembly according to claim 1 comprising no hard stop layer.

5. The gasketed fuel cell membrane electrode assembly according to claim 2 comprising no hard stop layer.

6. The gasketed fuel cell membrane electrode assembly according to claim 3 comprising no hard stop layer.

7. The gasketed fuel cell membrane electrode assembly according to claim 1 comprising a peripheral sealing zone in which said gasketed fuel cell membrane electrode assembly consists essentially of a ion conducting membrane and a closed-cell foam rubber gasket.

8. The gasketed fuel cell membrane electrode assembly according to claim 7 wherein said closed-cell foam rubber comprises silicone.

9. The gasketed fuel cell membrane electrode assembly according to claim 7 wherein said closed-cell foam rubber consists essentially of silicone.

10. The gasketed fuel cell membrane electrode assembly according to claim 1 comprising a peripheral sealing zone in which said gasketed fuel cell membrane electrode assembly consists essentially of a ion conducting membrane, an adhesive and a closed-cell foam rubber gasket.

11. The gasketed fuel cell membrane electrode assembly according to claim 10 wherein said closed-cell foam rubber comprises silicone.

12. The gasketed fuel cell membrane electrode assembly according to claim 10 wherein said closed-cell foam rubber consists essentially of silicone.

13. The gasketed fuel cell membrane electrode assembly according to claim 1 comprising a peripheral sealing zone in which said gasketed fuel cell membrane electrode assembly consists essentially of a catalyst coated membrane and a closed-cell foam rubber gasket.

14. The gasketed fuel cell membrane electrode assembly according to claim 13 wherein said closed-cell foam rubber comprises silicone.

15. The gasketed fuel cell membrane electrode assembly according to claim 13 wherein said closed-cell foam rubber consists essentially of silicone.

16. The gasketed fuel cell membrane electrode assembly according to claim 1 comprising a peripheral sealing zone in which said gasketed fuel cell membrane electrode assembly consists essentially of a catalyst coated membrane, an adhesive and a closed-cell foam rubber gasket.

17. The gasketed fuel cell membrane electrode assembly according to claim 16 wherein said closed-cell foam rubber comprises silicone.

18. The gasketed fuel cell membrane electrode assembly according to claim 16 wherein said closed-cell foam rubber consists essentially of silicone.
